(19) United States
(12) Patent Application Publication
(10) Pub. No.: US 2017/0038302 A1
(43) Pub. Date: Feb. 9, 2017

(54) STABILIZED TEST REAGENT

(71) Applicant: Dow Global Technologies LLC, Midland, MI (US)

(72) Inventors: Emmanuel Appiah-Amponsah, Royersford, PA (US); Brandon Michael Borowski, Saint Charles, IL (US); Emre Discekici, Buffalo Grove, IL (US)

(21) Appl. No.: 15/303,028

(22) PCT Filed: Apr. 6, 2015
(86) PCT No.: PCT/US2015/024448

§ 371 Date: Oct. 10, 2016

Related U.S. Application Data
(60) Provisional application No. 61/979,554, filed on Apr. 15, 2014.

(51) Int. Cl. G01N 21/78; G01N 31/22

(52) U.S. Cl. CPC G01N 21/78; G01N 31/22

(57) ABSTRACT

A 3-methyl-2-benzothiazolinone (MBTH) test reagent having improved stability.

This invention relates generally to a 3-methyl-2-benzothiazolinone (MBTH) test reagent having improved stability. More particularly, the invention relates to the composition and use of a MBTH test reagent for the improved colorimetric determination of glyoxal in biocidal formulations.

MBTH is a white, crystalline compound known for its application as a derivatizing agent for aldehydic compounds such as glutaraldehyde and glyoxal. While it has shown utility in High Performance Liquid Chromatography-UV applications for the measurement of various aldehydes, its utility in a qualitative, portable test kit format remains difficult due to the extremely short shelf life of MBTH when prepared as an aqueous solution. Although relatively stable as a solid, the use of MBTH solid for colorimetric tests where reagent stability is a key performance attribute raises other concerns resulting from versatility, ease of use, and sustainability. To circumvent these issues while concomitantly enhancing the robustness of a portable test kit, the present invention provides an innovative solution by positioning MBTH as a stabilized aqueous solution for the sensitive and selective detection of glyoxal, a compound identified as a potential adulterant in glutaraldehyde products. By the use of citric acid as a stabilizer, an ultra-stabilized MBTH aqueous reagent solution is obtained which offers substance specific detection of as low as 1.0% glyoxal in mixtures containing other aldehydic compounds within a few minutes.

The present invention is directed to an improved, stabilized aqueous test reagent comprising a mixture of 3-methyl-2-benzothiazolinone, a soluble acid, and water; wherein the soluble acid is present in an amount less than or equal to 1%. Secondly, the present invention is directed to a method of determining glyoxal in a formulation comprising:

a) providing a formulation comprising glyoxal and

b) adding the reagent of claim 1

c) observing a color change after the reagent is added.

All percentages are weight percentages (“wt. %”) and temperatures in ° C., unless otherwise indicated. Experiments were performed at room temperature (20-25° C.), unless otherwise indicated. As used herein, the term “stability” or “stable” is defined as four times the absorbance measurement at a wavelength of 374 nm of the stabilized solution at room temperature. In the present invention, the stability value of the reagent is less than the unstablized solution then the reagent is said to be more stable.
Stability (S)=4(A₀)
A₀=Absorbance of the stabilized solution at wavelength of 374 nm stored at ambient conditions.

Also, as used herein, “soluble” is defined as from 95-100% dissolution in 99% H₂O at 25° C. By “soluble acid” is meant an aqueous compound that has 95-100% dissolution in at least 99% H₂O at 25° C. and further is capable of adjusting the pH of the reagent to a value from 2.4 to 3.0. Soluble acids may be one acid or mixtures of acids.

According to the present invention, the reagent comprises a soluble acid. The soluble acisd is present in an amount of less than or equal to 1%, preferably less than or equal to 0.5%, preferably, less than or equal to 0.2%. Preferably, the soluble acid comprises citric acid. The citric acid is present in an amount from 0.06 to 0.1 weight percent based on total weight of the reagent, alternatively 0.1 wt. %. Further, the reagent comprises 0.05 to 0.1 weight percent based on total weight of the reagent of MBTH, alternatively, 0.08 wt. % MBTH. Lastly the reagent comprises water in an amount from 99.80 to 99.89 weight percent based on total weight of the reagent, alternatively 99.82 wt. % water.

Additionally according to the present invention, the reagent is proven to be stable longer as compared to MBTH reagents with other organic acids or MBTH alone. Particularly the reagent of the present invention is stable when stored at elevated temperatures. In the present invention, the reagent comprises a temperature of greater than or equal to 40° C. at the time of mixture, alternatively a temperature of greater than or equal to 40° C. at a point in time after 6 days from forming the mixture, further alternatively the reagent comprises a temperature of greater than or equal to 40° C. at a point in time after 13 days from forming the mixture.

Additionally according to the method of the present invention, the reagent comprises a temperature of greater than or equal to 40° C. at a point in time after 6 days from forming the mixture, alternatively a temperature of greater than or equal to 40° C. at a point in time after 13 days from forming the mixture.

Preferably, the pH of the aqueous test reagent is from 0.5 to 7, preferably from 1.5 to 5, preferably from 2 to 3.5, preferably from 2.4 to3,

The present invention is further directed to a method for detecting glyoxal in which a sample to be tested for glyoxal is combined with the reagent and either a visual observation is made of a color change or an absorbance reading is taken to detect an absorption at approximately 420 nm. Preferably, the sample and the reagent are contacted at room temperature, preferably for at least one minute, preferably for at least three minutes. Times over ten minutes are not necessary.

### EXAMPLES

### Reagents

3-methyl-2-benzothiazolinone hydrochloride (MBTH), 99% citric acid, and 37% formaldehyde were obtained from Sigma Aldrich (St Louis, Mo.). 99% glacial acetic acid and 37% hydrochloric acid were obtained from Fisher Scientific International Inc. (Hampton, N.H.). Pure 50% glutaraldehyde was obtained from The Dow Chemical Company CIG group (Midland, Mich.). Deionized water was obtained from a Milli Q-Academic water purification system provided by Millipore (Bedford, Mass.).

### MBTH Reagent Variations:

A: 0.08% MBTH
B: 0.08% MBTH; 0.06% acetic acid
C: 0.08% MBTH; 0.06% citric acid
D: 0.08% MBTH; 0.10% citric acid

### Sample Preparation

The following mixtures of glutaraldehyde based solutions were used for the qualitative study and were prepared in order to replicate adulterated samples:
1: 50% pure glutaraldehyde
2: 25% glutaraldehyde; 10% formaldehyde
3: 25% glutaraldehyde; 10% formaldehyde; and 1% glyoxal
The above samples were then subsequently diluted ˜1:2000 times in Millipore grade water before proceeding with test procedure.

### Glyoxal Detection Test Procedure (Qualitative)

To address concerns like versatility, sustainability, and poor shelf-life of aqueous based MBTH reagent, reagent variations using citric acid and acetic acid were initially prepared to test whether or not they still effectively catalyzed the formation of the desired yellow diazine in the presence of glyoxal. Two control samples, an unadulterated glutaraldehyde and a glutaraldehyde/formaldehyde mixture, in addition to a mixture containing 1.0% glyoxal were used throughout the duration of the study. It was found that MBTH successfully produced the distinct yellow color indicative of glyoxal contamination in the 1.0% glyoxal containing mixture, while both controls simple yielded a white precipitate. The reagents were subsequently stored at 25° C. and 40° C. in order to simulate conditions in which the test kit may be stored. Each MBTH variation was then tested at various time points within a 2-week time frame to determine if both stability and efficacy is maintained despite harsh storage conditions. Throughout the 2-weeks, all stabilized variations were determined to still be efficacious in detecting a ˜1:2000 times diluted 1.0% glyoxal, while the unstabilized reagent control formed characteristic brown degradants that began to interfere with the formation of the desired yellow color, ultimately deeming it inefficacious within 2-weeks. The test reaction was performed by adding 2.0 mL of diluted sample to 1.0 mL of MBTH reagent and allowing the reaction to take place for 5-7 minutes. The emergence of a yellow color is indicative of glyoxal presence. A 1:2 reagent to sample ratio was combined in a small clear vial. If the solution turned yellow within a few minutes, the assay resulted in a pass. If no yellow color appears, the assay resulted in a fail. The results were analyzed visually and the results are displayed in Tables 1C and 1D below.

TABLE 1A
Table showing pH readings of each variation
(25° C.) measured at 374 nm on each
time point throughout the study

| pH | Variation stored at 25° C. | | | |
|---|---|---|---|---|
| Day | A | B | C | D |
| 0 | 4.391 | 3.387 | 2.872 | 2.778 |
| 1 | 4.589 | 3.506 | 2.979 | 2.822 |
| 3 | 4.553 | 3.404 | 2.894 | 2.738 |
| 7 | 4.198 | 3.416 | 2.916 | 2.750 |
| 14 | 3.730 | 3.462 | 2.934 | 2.885 |

TABLE 1B
Table showing pH readings of each variation
(40° C.) measured at 374 nm on each
time point throughout the study

| pH | Variation stored at 40° C. | | | |
|---|---|---|---|---|
| Day | A | B | C | D |
| 0 | 4.291 | 3.387 | 2.872 | 2.778 |
| 1 | 4.675 | 3.475 | 2.962 | 2.83 |
| 3 | 4.508 | 3.425 | 2.922 | 2.782 |
| 7 | 4.201 | 3.428 | 2.926 | 2.779 |
| 14 | 3.648 | 3.447 | 2.921 | 2.862 |

TABLE 1C

| | Reagent Variation Efficacy with | | | |
|---|---|---|---|---|
| 25° C. | Sample 3 | | | |
| Day | A | B | C | D |
| 0 | Pass | Pass | Pass | Pass |
| 1 | Pass | Pass | Pass | Pass |
| 3 | Pass | Pass | Pass | Pass |
| 7 | Pass | Pass | Pass | Pass |
| 14 | Fail | Pass | Pass | Pass |

TABLE 1D

| | Reagent Variation Efficacy with | | | |
|---|---|---|---|---|
| 40° C. | Sample 3 | | | |
| Day | A | B | C | D |
| 0 | Pass | Pass | Pass | Pass |
| 1 | Pass | Pass | Pass | Pass |
| 3 | Pass | Pass | Pass | Pass |
| 7 | Fail | Pass | Pass | Pass |
| 14 | Fail | Fail | Pass | Pass |

### Tracking Degradation of Aqueous Based MBTH Reagent by UV-Spectroscopy (Quantitative)

The test reaction was performed by adding 2.0 mL of diluted sample to 1.0 mL of MBTH reagent and allowing the reaction to take place for 5-7 minutes. Using a UV-Vis spectrophotometer, initial scans ranging from 190 nm to 1100 nm, of a degraded aqueous MBTH solution were conducted in order to determine the λₘₐₓ of the degraded reagent. It was determined that the μₘₐₓ was 374 nm. As a result, all subsequent absorbance readings of MBTH reagent compositions were measured at 374 nm

TABLE 2A
Table showing absorbance readings of each variation (25° C.)
measured at 374 nm on each time point throughout the study

| 25° C. | Reagent Variation Abs @ 374 nm | | | |
|---|---|---|---|---|
| Day | A | B | C | D |
| 0 | 0.001 | 0.0002 | 0.0003 | 0.0018 |
| 1 | 0.0087 | 0.0034 | 0.0036 | 0.0063 |
| 3 | 0.0187 | 0.0048 | 0.0033 | 0.0028 |
| 7 | 0.0762 | 0.0073 | 0.0062 | 0.0078 |
| 14 | 0.3260 | 0.0172 | 0.0079 | 0.0141 |

NOTE: This Table 1A demonstrates that without stabilization, the reagent can undergo accelerated degradation and ultimately be rendered useless for the intended application of detecting glyoxal due to strong interference of the resulting brown degradant.

TABLE 2B
Table showing absorbance readings of each variation (40° C.)
measured at 374 nm on each time point throughout the study

| 40° C. | Reagent Variation Abs @ 374 nm | | | |
|---|---|---|---|---|
| Day | A | B | C | D |
| 0 | 0.001 | 0.0002 | 0.0003 | 0.0018 |
| 1 | 0.0238 | 0.0096 | 0.0063 | 0.0081 |
| 3 | 0.0794 | 0.0165 | 0.0106 | 0.0108 |
| 7 | 0.4142 | 0.0292 | 0.0123 | 0.0158 |
| 14 | 0.9902 | 0.1439 | 0.0303 | 0.0225 |

The measured absorbance values provide striking evidence supporting the enhanced stability and equal if not greater efficacy of the citric acid when compared to a chemically similar acid, acetic acid, or no acid at all.

MBTH alone showed the greatest instability at both 25° C. and 40° C., as its increase in absorbance over time was the most rapid. The acetic acid showed an increase in absorbance and therefore a decrease in stability over an extended period of time (i.e. 14 days) and thus indicated relatively poor stability in comparison to citric acid.

The citric acid variation was determined to be the most stable at both 25° C. and 40° C., with the latter illustrating an overwhelming difference in stability. By observing the same correlation across two different storage conditions, we can conclude that the MBTH alone and acetic acid is considerably less stable than the citric acid and that its instability is further accelerated with elevated temperatures.

1. An improved, stabilized aqueous test reagent comprising a mixture of 3-methyl-2-benzothiazolinone, a soluble acid, and water;
wherein the soluble acid is present in an amount less than or equal to 1%.

2. The reagent of claim 1 in which the soluble acid is citric acid.

3. The reagent of claim 2 in which the citric acid is present in an amount from 0.06 to 0.1 weight percent based on total weight of the reagent.

4. The reagent of claim 1 in which the 3-methyl-2-benzothiazolinone is present in an amount from 0.05 to 0.1 weight percent based on total weight of the reagent.

5. The reagent of claim 1 in which the water is present in an amount from 99.80 to 99.89 weight percent based on total weight of the reagent.

6. The reagent of claim 1 wherein the reagent comprises a pH of from 2.4 to 3.

7. A method of determining glyoxal in a formulation comprising:
a) providing a formulation comprising glyoxal and
b) adding the reagent of claim 1
c) observing a color change after the reagent is added.
